(19) United States
(12) Patent Application Publication
(10) Pub. No.: US 2021/0065047 A1
(43) Pub. Date: Mar. 4, 2021

(54) MULTI-TIERED SYSTEM FOR SCALABLE ENTITY REPRESENTATION LEARNING

(71) Applicant: Microsoft Technology Licensing, LLC, Redmond, WA (US)

(72) Inventors: Baoxu Shi, San Jose, CA (US); Jaewon Yang, Campbell, CA (US); Qi He, San Jose, CA (US)

(21) Appl. No.: 16/556,097

(22) Filed: Aug. 29, 2019

(51) Int. Cl. G06N 20/00; G06N 5/04

(52) U.S. Cl. CPC G06N 20/00; G06N 5/04

(57) ABSTRACT

Techniques for learning entity representations in a scalable manner are provided. A graph that comprises a plurality of nodes representing a set of entities is stored. A first subset of the set of entities and a second subset of the set of entities are identified. For each entity in the first subset of the set of entities, one or more machine learning techniques are used to generate a machine-learned embedding for the entity. For each entity in the second subset of the set of entities, a subset of entities in the first subset that are associated with the entity is identified. One or more embeddings are identified for the subset of entities. Based on the one or more embeddings, an inferred embedding is generated for the entity.

### TECHNICAL FIELD

The present disclosure relates to machine learning and, more particularly to, learning entity representations of multiple entities in a scalable way.

### BACKGROUND

Graph analysis is an important type of data analytics where the underlying data-set is modeled as a graph. Since such a graph representation captures relationships between data entities, applying graph analysis procedures can provide valuable insight about the original data-set to the user. Examples of popular graph analysis procedures are Community Detection, PageRank, Shortest Path Finding, and Link Prediction.

One example of a graph models users in an online network. Nodes in the graph represent users and edges represent relationships or connections between users. Some nodes in the graph may represent other types of entities, such as organizations (e.g., companies, schools), job titles, skills, industry, job openings, etc., with which a user may be associated or affiliated.

In order to understand relationships among entities in a graph, each entity should be represented in the same semantic space so any two arbitrary entities can be compared directly. However, existing learning methods to generate entity representations are not suitable for at least two related reasons. First, the graph can be large and evolve at a rapid pace. For example, new users are added to the online network daily, some companies are growing by adding employees quickly, other companies are shrinking, and some skills are becoming less popular. Second, in order to reflect these changes in entity representations, the entire training algorithm needs to be re-run regularly. However, re-running the training algorithm takes a significant amount of time and many computing resources, including computing memory and CPU cycles.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for generating embeddings, in an embodiment;

FIG. 2 is a flow diagram that depicts an example process for inferring embeddings, in an embodiment;

FIG. 3 is a flow diagram that depicts an example process for inferring embeddings for entities of a particular type, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for generating embeddings for entities represented in a graph are provided. In one technique, embeddings for a first subset of the entities generated using machine learning techniques while embeddings for a second set of the entities are generated based on inference from the machine-learned embeddings. The process for learning embeddings for entities in the first subset takes a significant amount of time relative to the process of inferring embeddings from already-learned embeddings. If the number of entities in the first subset may be much smaller than the number of entities in the second subset, then this technique achieves a significant reduction in the time and resources required to generate embeddings for every entity in the graph. Also, for changes to the graphs, re-learning embeddings for entities in the first subset can be avoided, while inferred embeddings may be updated.

Therefore, embodiments improve the functioning of a computer system that generates embeddings for entities represented in a graph as a result of this two-tiered technique. Indeed, embodiments make it possible to reflect the latest graph changes in embeddings in a fraction of the time (e.g., minutes or hours) compared to a naïve approach (e.g., days or weeks) where machine-learned embeddings would have to be re-generated “from scratch.” Additionally, valuable computing resources are conserved since the process of relearning embeddings for many entities is avoided.

### System Overview

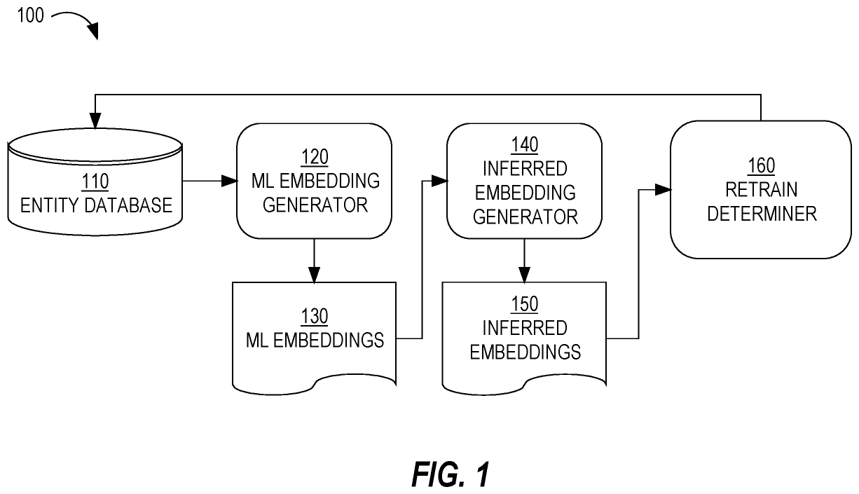

FIG. 1 is a block diagram that depicts an example system 100 for generating embeddings, in an embodiment. System 100 comprises entity database 110, ML embedding generator 120, ML embeddings 130, inferred embedding generator 140, inferred embeddings 150, and retrain determiner 160. Each of ML embedding generator 120, inferred embedding generator 140, and retrain determiner 160 may be implemented in software, hardware, or any combination of software and hardware.

Entity database 110 may be implemented on one or more storage devices. The storage devices may include volatile and/or non-volatile memory. Entity database 110 may be one of many types of databases, such a relational, object-oriented, object-relational, NoSQL, key-value, or NewSQL. Embodiments are not limited to the type of data that entity database 110 stores or the type of requests that client devices might submit.

Entity database 110 stores multiple records, one for each entity of multiple entities. An entity represents an (e.g., real-world) object, such as a person or an organization (e.g., a company), or an attribute, such as a skill, a job title, a geographic location, an academic degree earned, etc. For example, if entity database 110 is a key-value store, then each record comprises a key-value pair, where the key is user identifier and the value is a list of attribute values. Each attribute value in the list may encode the attribute type of that value.

There are two main types or categories of entities: attribute entities and non-attribute entities. A non-attribute entity (or an entity of the non-attribute type) may be associated with multiple objects or attributes. For example, in an online social network, a user may be connected to (or be “friends” with) multiple other users. Also, each user may be associated with multiple attributes, such as a school that the user attended, an employer of the user, a list of skills of the user. Thus, a non-attribute entity may be associated with other non-attribute entities and attribute entities.

In an embodiment, an attribute entity (or an entity of the attribute type) does not include other entities. In a related embodiment, entity database 110 does not include a record for attribute entities, only non-attribute entities.

Some entities may be both an attribute entity and a non-attribute entity, such as an organization. For example, a company may be an attribute of a user if the company is listed as an employer of the user in a record or profile of the user. At the same time, a company may include multiple attributes, such as industry, size in number of employees and/or offices, geographic location(s), number of job openings, etc. Entity database 110 is described in more detail herein.

ML embedding generator 120 uses one or more machine learning techniques to generate embeddings for a subset of entities represented in entity database 110. The generated embeddings are stored as ML embeddings 130. ML embeddings 130 may be stored on the same or different storage device(s) as the storage device(s) upon which entity database 110 is stored. Techniques for generating ML embeddings is described in more detail herein.

Inferred embedding generator 140 generates inferred embeddings 150 for certain entities using one or more techniques that do not involve machine learning where surrounding embeddings of adjacent entities of a particular entity are used to learn an embedding for the particular embedding. Instead, an inferred embedding for a particular entity is generated based on the ML embeddings of entities associated with the particular entity (and, possibly, based on other inferred embeddings). Techniques for generating inferred embeddings (such as pooling and autoencoding) are described in more detail herein.

Retrain determiner 160 determines whether to retrain ML embeddings 130 or to generate ML embeddings for a new set of entities. The determination is described in more detail herein.

### Entity Database

Each non-attribute entity record stored in entity database 110 includes profile information that may be provided by a different user. Examples of non-attribute entities include users, groups of users, and organizations (e.g., companies, associations, government agencies, etc.). A user profile may include a first name, last name, an email address, residence information, a mailing address, a phone number, one or more educational institutions attended, one or more current and/or previous employers, one or more current and/or previous job titles, a list of skills, a list of endorsements, and/or names or identities of friends, contacts, connections of the user, and derived data that is based on actions that the candidate has taken. Examples of such actions include jobs to which the user has applied, views of job postings, views of company pages, private messages between the user and other users in the user's social network, and public messages that the user posted and that are visible to users outside of the user's social network (but that are registered users/members of the social network provider).

An organization profile may include a name, a mailing address, an email address, a phone number, names of principals or owners of the organization, a size of the organization, a number of job openings available at the organization, a year the organization was formed, an industry, skills sought by the organization, and job titles sought by the organization. An organization may be associated with users based on the users' profiles identifying the organization as an employer of the users or as affiliated with the users in some other way.

Some data within a user's profile (e.g., work history) may be provided by the user while other data within the user's profile (e.g., skills and endorsement) may be provided by a third party, such as a “friend,” connection, or colleague of the user.

A server system that interfaces with client devices over a computer network (none of which is depicted) may prompt users to provide profile information in one of a number of ways. For example, the server system may have provided a web page with a text field for one or more of the above-referenced types of information. In response to receiving profile information from a user's device, the server system stores the information in an account that is associated with the user and that is associated with credential data that is used to authenticate the user to the server system when the user attempts to log into the server system at a later time. Each text string provided by a user may be stored in association with the field into which the text string was entered. For example, if a user enters “Sales Manager” in a job title field, then “Sales Manager” is stored in association with type data that indicates that “Sales Manager” is a job title. As another example, if a user enters “Java programming” in a skills field, then “Java programming” is stored in association with type data that indicates that “Java programming” is a skill.

In an embodiment, the server system stores access data in association with a user's account. Access data indicates which users, groups, or devices can access or view the user's profile or portions thereof. For example, first access data for a user's profile indicates that only the user's connections can view the user's personal interests, second access data indicates that confirmed recruiters can view the user's work history, and third access data indicates that anyone can view the user's endorsements and skills.

In an embodiment, some information in an entity profile is determined automatically by the server system (or another automatic process). For example, a user specifies, in his/her profile, a name of the user's employer. Server system then determines, based on the name, where the employer and/or user is located. If the employer has multiple offices, then a location of the user may be inferred based on an IP address associated with the user when the user registered with a social network service (e.g., provided by the server system) and/or when the user last logged onto the social network service.

Entities indicated in entity database 110 may be modeled as a graph of nodes, each node representing an entity, whether an attribute entity or a non-attribute entity. In fact, a graph may be generated based on the entity data in entity database 110 and stored separate from the entity data. Such a graph may allow graph-based operations to be performed more efficiently. An edge connecting two nodes may indicate whether the relationship is between non-attribute entities or between a non-attribute entity and an attribute entity.

While many examples herein are in the context of online social networking, embodiments are not so limited.

### Embeddings

An embedding is a vector of real numbers. “Embedding” is a name for a set of feature learning techniques where words or identifiers are mapped to vectors of real numbers. Conceptually, embedding involves a mathematical embedding from a space with one dimension per word/phrase (or identifier) to a continuous vector space.

Embeddings have multiple purposes, such as finding nearest neighbors in the embedding space (which can be used to make recommendations), as input to a machine-learned model for a supervised task, and for visualization of concepts and relations between categories.

One method to generate embeddings includes artificial neural networks. In the context of linguistics, word embedding, when used as the underlying input representation, has been shown to boost performance in natural language processing (NLP) tasks, such as syntactic parsing and sentiment analysis. Word embedding aims to quantify and categorize semantic similarities between linguistic items based on their distributional properties in large samples of language data. The underlying idea that a word is characterized by “the company it keeps.”

For example, a text corpus includes the sentence, “A quick brown fox jumps over the lazy dog.” Two words are randomly sampled from this sentence: {source: “jumps”} and {target: “fox”}. The embeddings for these words are optimized to maximize P(“fox”|“jumps”). A skip-gram model may be leveraged to predict a target word (or surrounding words) given a source word (or “center” word).

In an embodiment, in the context of a graph of nodes, an embedding is learned for each of multiple entities represented by the graph nodes. The values of such entities may be string values or numeric identifiers. For example, a value of a company entity may be a name (e.g., string of non-numeric characters) of the company (e.g., “Company X”) or an identifier (e.g., “435256”) that uniquely identifies the company.

Each embedding represents something different. For example, an embedding for a particular job title represents attributes of different users with that particular job title. As another example, an embedding for a user represents attributes of the user and, potentially, how the user is connected in a graph.

Before a neural network is trained for producing embeddings, each entity is assigned an initial embedding. The initial embedding for each entity may be randomly generated. During the training process (which is described in more detail herein), each embedding is continuously modified until the embedding “stabilizes”, such that the object value that is being optimized stops significantly improving. Training may be performed in small batches and embeddings may be updated after each batch. A stabilized embedding becomes a “final” embedding for the corresponding entity. A final embedding may be stored in a mapping or table of multiple final embeddings. For example, one table may store associations between final embeddings and their corresponding users and another table may store associations between final embeddings and their corresponding attributes. An attribute may be uniquely identified with an attribute identifier, a name (e.g., “Company X” or “Java”), and a type, such as skill, company, or job title.

Specifically, the training process involves identifying a set of attribute values (or entities) for each of multiple non-attribute entities indicated in entity database 110. Each attribute value may have already been assigned an initial embedding. An attribute entity “sentence” is created for each non-attribute (e.g., user) entity. The “sentence” is the set of attribute entities of the non-attribute entity. The set may be in any order. Source and target entities are sampled from the sentence. For example, if a user is associated with eight attribute entities, then the total number of samples may be determined by a hyper-parameter called “number-of-samples-per-attribute” N, such as between five and ten. For each entity, N number of target entities are sampled for prediction. Thus, given this example, in total 8*N samples are taken.

The embeddings of the source and target entities are optimized to maximize the probability of a target attribute entity given a source attribute entity (i.e., P(target|source)). The probability P(target|source) is determined by the given source-target pair. For example, the value of P(target|source) may be calculated by dividing (a) the sum of all instances where the target is adjacent to the source by (b) the sum of all instances of the source. Also, the same source-target pair can be used multiple times in the training process.

The training process involves gradient descent and backpropagation. Gradient descent is an iterative optimization algorithm for finding the minimum of a function; in this case, a loss function. Backpropagation is a method used in artificial neural networks to calculate the error contribution of each neuron after a batch of data is processed. In the context of learning, backpropagation is used by a gradient descent optimization algorithm to adjust the weight of neurons (or nodes) in a neural network by calculating the gradient of the loss function. Backpropagation is also referred to as the “backward propagation of errors” because the error is calculated at the output and distributed back through the network layers. For models involving embeddings, there is an implicit input layer that is often not mentioned. The embeddings are actually a layer by themselves and backpropagation goes all the way back to the embedding layer. The input layer maps inputs to the embedding layer. Backpropagation begins at the final (output) layer that generates the probabilities and is applied per batch. Batch size depends on several factors, including the available memory on the computing device or GPU.

For example, employer “LinkedIn” may be mapped to “employer=12345”. For each instance in which a user lists “LinkedIn” as his/her employer, the random vector for “employer=12345” would be the same. The initial random vector for employer=12345 is modified after some training, the modified vector is retained, and the modified vector is used the next time employer=12345 appears during the training process.

After generating embeddings for different entities during the training process, the embeddings are associated with their respective entities. For example, an embedding for a particular user is stored in association with the particular user (such as a unique user identifier). Similarly, an embedding for a particular skill (e.g., “Cloud Computing”, which may be mapped for a particular internal identifier that represents that skill) is stored in association with that particular skill.

### Selecting Entities for which ML Embeddings Will be Generated

In an embodiment, one or more criteria are used to select entities for which machine-learned (ML) embeddings will be generated. Example criteria include the frequency with which the entity appears in entity database 110 and the type of entity. For example, if an entity occurs more than one thousand times in entity database 110, then the entity is selected. As another example, if an entity is a user (thus, of the user type), then the entity is not selected, regardless of the number of times the user is listed in profiles as a connection of other users.

In order to determine frequency, entity database 110 is analyzed to determine a number of times each entity appears in entity database 110. For example, each specific skill is recorded (e.g., in a separate table) and a counter is increased each time the specific skill is identified in a user's profile and/or a company's profile. For example, if a skill appears in twenty user profiles, then the frequency of that skill is twenty.

In a related embodiment, different types of entities are associated with different frequency thresholds. For example, skills are associated with a first threshold (e.g., two thousand), while industry is associated with a second threshold (e.g., two hundred thousand) that is different than the first threshold, while company is associated with a third threshold (e.g., two hundred) that is different than the first and second thresholds.

All entities that have not been selected may be candidates for inferred embedding generation. However, in an embodiment, inferred embedding generator 140 does not generate an inferred embedding for some entities reflected in entity database 110. Such a decision may be based on the frequency or number of instances of the entities in entity database 110. For example, if a particular skill does not appear at least one hundred times in different user profiles, then an inferred embedding is not generated for the particular skill.

In an embodiment, ML embeddings are not generated for one or more types of entities, such as users and organizations. Instead, inferred embeddings are generated for such entities.

### Inferred Embeddings

An inferred embedding is an embedding that is not generated directly using machine learning. Instead, an inferred embedding is an embedding that is generated by aggregating multiple embeddings, at least one of which was generating using one or more machine learning techniques. Examples of aggregation techniques to combining multiple embeddings include pooling, average by entity type, autoencoder, and transformer.

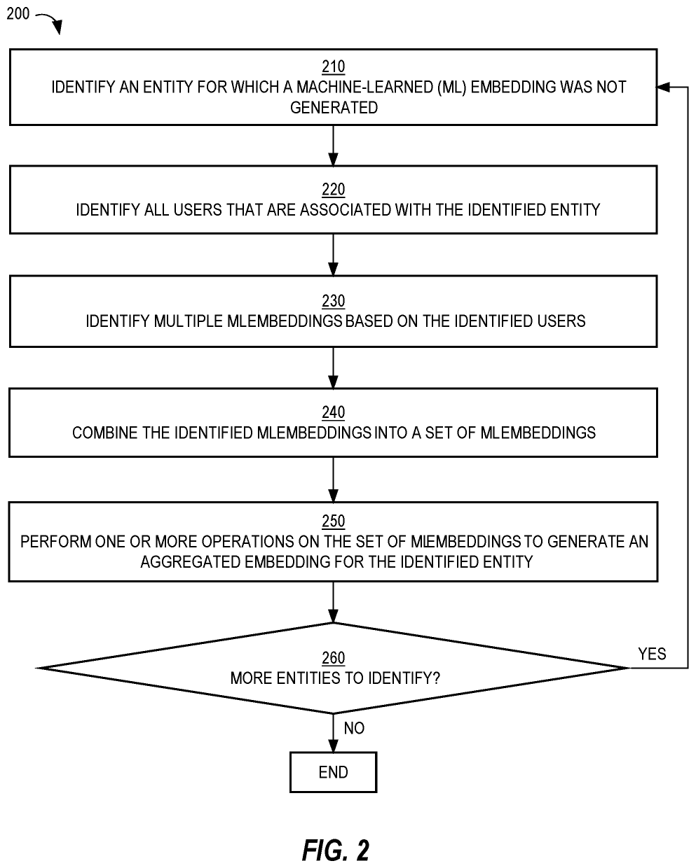

FIG. 2 is a flow diagram that depicts an example process 200 for inferring embeddings, in an embodiment. Process 200 may be performed by inferred embedding generator 140. There may be different processes for different types of entities. For example, process 200 may be used for non-user entities while another process (described in more detail herein) is used for user entities.

At block 210, an entity for which an ML embedding was not generated is identified. Such an entity might not have been selected previously for generating an ML embedding due to the entity's low frequency among the entities indicated in entity database 110. Also, such an entity may be limited to non-user entities.

At block 220, all users that are associated with the identified entity are identified. For example, an entity is “C programming” and has an entity type of skill. All users that list “C programming” as a skill in their respective profiles are identified.

Block 220 may involve scanning each user entity's profile in entity database 110 and determining whether the profile lists the identified entity. Alternatively, block 220 may involve using an index that has been generated based on the data in entity database 110 to identify the profiles that list the identified entity. For example, the entity may be of type job title and a job title index has already been generated based on the records in entity database 110. The job title index includes, for each job title, an entry that identifies one or more records in which the job title appears.

At block 230, multiple ML embeddings are identified based on the identified users. For each identified user, zero or more ML embeddings are identified. For example, one user might not be associated with any ML embeddings while other users may be stored with one, two, or more ML embeddings.

Embodiments are not limited to where the ML embeddings are stored for retrieval. For example, each user record in entity database 110 may store a list of ML embeddings for attributes of the user. Alternatively, a separate attribute table may store an association between an attribute entity name and an ML embedding. If an ML embedding has not been generated for an attribute, then the attribute entity name might not exist in the attribute table.

At block 240, the identified ML embeddings are combined into a set of ML embeddings. The set of ML embeddings may be a list that contains all the identified ML embeddings. Such a list may contain duplicate ML embeddings, in which case the ML embedding of a first entity that appears many times in association with a particular entity will have a larger effect on the inferred embedding for the particular entity than the ML embedding of a second entity that only appears once or a few times in association with the particular entity. Alternatively, the set of ML embeddings may be restricted to include no more than N (e.g., one or two) instances of each ML embedding.

At block 250, one or more operations may be performed on the set of ML embeddings to generate an aggregated ML embedding for the identified entity. An example operation is a pooling operation. There are different types of pooling, such as max pooling, mean pooling, and minimum pooling. Also, there is percentile pooling, such as identifying the median (or 50^{th} percentile) or 80^{th} percentile. For example, max pooling involves, given a set of embeddings of a particular length, for each index into the embeddings, the maximum value found at that index among all embeddings in the set is determined. For example, if the values at the first entry of three embeddings are 23, 43, and 35, then the maximum value for the first entry of the inferred embedding would be 43. The aggregated ML embedding may be used as the inferred embedding.

Alternatively, the aggregated ML embedding may be combined with another aggregated embedding to generate an inferred embedding for the identified entity. The other aggregated embedding may be generated by aggregating (e.g., averaging) embeddings for the corresponding type of entity. The aggregated embedding for the entity type may then be combined with the entity-specific aggregated ML embedding to generate an inferred embedding for the identified entity. For example, for the skills entity type, the ML embeddings for all skills for which a ML embedding has been generated are averaged to generate an aggregated ML embedding for skills. Then, for a first skill (e.g., C programming), the inferred embedding for the first skill is generated by combining (1) the aggregated ML embedding for skills with (2) the aggregated ML embedding for the specific skill (e.g., generated using max pooling). For a second skill (e.g., software engineering), the inferred embedding for the second skill is generated by combining (1) the aggregated ML embedding for skills with (2) the aggregated ML embedding for the specific skill. Thus, for both skills, the same aggregated ML embedding for the skills type is used to generate the inferred embeddings of the respective skills.

The combining of the two embeddings (entity specific and entity type) may include an average of the embeddings or a weighted average. For example, the entity-specific aggregated ML embedding may be weighted more (e.g., 0.8 v. 0.2) than the entity-type aggregated ML embedding.

An alternative approach to aggregating or combining multiple aggregated embeddings using pooling or any variation thereof is using an autoencoder. An autoencoder is a type of artificial neural network used to learn efficient representations (embeddings) in an unsupervised manner. An aim of an autoencoder is to learn a representation for a set of data, typically for dimensionality reduction, by training the network to ignore signal “noise”. Along with the reduction side, a reconstructing side is learnt, where the autoencoder tries to generate, from the reduced embedding, a representation as close as possible to its original input, hence its name. Several variants exist to the basic model, with the aim of forcing the learned representations of the input to assume useful properties. Examples are regularized autoencoders, such as sparse, denoising, and contractive autoencoders.

At block 260, it is determined whether there are any more entities to identify. If so, then process 200 returns to process 210. If not, then process 200 may end, at least for certain types of entities.

### Inferred Embeddings for Users

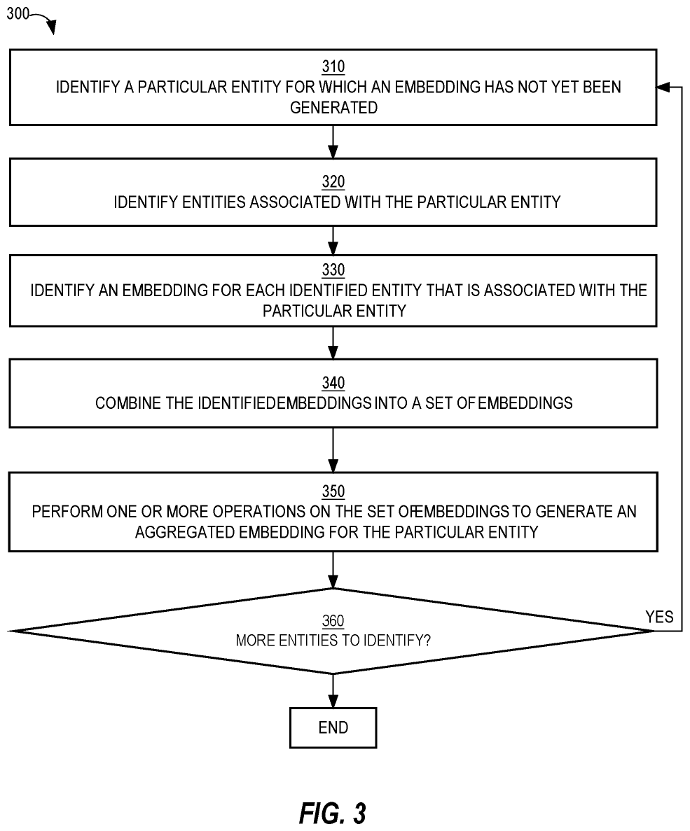

FIG. 3 is a flow diagram that depicts an example process 300 for inferring embeddings for entities of a particular type, in an embodiment. For example, the particular type is user. Process 300 may also be performed by inferred embedding generator 140. Process 300 is similar to process 200.

At block 310, a particular entity for which an embedding has not yet been generated is identified. In an embodiment, such an entity is limited to non-attribute entities, such as users. An embedding may have been generated for the particular entity in a previous round of embedding generation for entities indicated in entity database 110, such as one that was performed six months prior to the current time. However, during the current round of training, an embedding has not yet generated for the particular entity.

At block 320, entities associated with the particular entity are identified. For example, the particular entity is a particular user and the particular user, according to a record in entity database 110, is associated with (e.g., by listing in the particular user's profile) job title A, employer B, industry C, and skills D and E. The entities that are identified in block 320 may be limited to certain types of entities and not all entities or attributes of particular user.

At block 330, for each identified entity that is associated with the particular entity, an embedding for the identified entity is identified. Continuing with the example above, an embedding for job title A is identified, an embedding for employer B is identified, an embedding for industry C is identified, and embeddings for skills D and E are identified.

Some of the identified embeddings may be inferred embeddings while other identified embeddings may be ML embeddings. Thus, in one example when generating inferred embeddings for different users, for a first user, only inferred embeddings are identified; for a second user, only ML embeddings are identified; and for a third user, inferred embeddings and ML embeddings are identified.

Embodiments are not limited to where the embeddings are stored for retrieval. For example, each user record in entity database 110 may store a list of embeddings for attributes of the user. Alternatively, a separate attribute table may store an association between an attribute entity name and an embedding. If an embedding has not been generated for an attribute (whether ML or inferred), then the attribute entity name might not exist in the attribute table.

At block 340, the identified embeddings of the particular entity are combined into a set of embeddings. The set of embeddings may be a list that contains all the identified embeddings for the particular entity. If the record (or profile) of the particular entity does not contain any duplicate values, then there should not be any duplicate embeddings associated with the particular entity.

At block 350, one or more operations (e.g., pooling) may be performed on the set of embeddings to generate an aggregated embedding for the particular entity. The aggregated embedding may be used as the inferred embedding. An alternative approach to generating an aggregated embedding is using an autoencoder.

At block 360, it is determined whether there are any more entities to identify. If so, then process 300 returns to process 310. If not, then process 300 may end. Process 300 may continue until each entity that is not associated with an embedding will have an embedding generated for that entity. Alternatively, there may be some entities for which no embedding will be generated, such as entities whose instances in entity database 110 is total less than a certain number, such as ten.

### Multiple Embeddings Maintained for a Non-Attribute Entity

Embeddings for a non-attribute (e.g., a user or an organization) entity may be leveraged by one or more downstream processes in one or more ways. For example, one downstream process may only require a user's inferred embedding while another process may require multiple embeddings of certain attributes of the user (e.g., employer, job title, and skill). As a specific example, a feature of a click prediction model is a user embedding. Thus, some user embeddings are used to train the click prediction model and others may be used as input to the click prediction model to produce a click prediction for individual users. As another specific example, features of a view prediction model include multiple attributes of a user, including job title, industry, current employer, and geographic region. Thus, some entity embeddings for those types of entities are used to train the view prediction model and other entity embeddings may be used as input to the view prediction model to produce a view prediction for individual users. (Some embeddings for a non-attribute entity may be ML embeddings while other embeddings for the non-attribute entity may be inferred embeddings. This may mean that some attributes of the non-attribute entity are common or appear frequently in a node graph while other attributes of the non-attribute entity are not common or appear infrequently in the node graph.)

Therefore, in an embodiment, multiple embeddings are generated for and associated with a non-attribute entity, such as a user or an organization. For example, for each user entity, an inferred embedding generated using max pooling is stored in association with the user entity, an inferred embedding generated using average pooling is stored in association with the user entity, and a list of embeddings (upon which the inferred embeddings are generated) is stored in association with the user entity. If the user entity is associated with multiple embeddings of attribute entities of the same type (e.g., employer or skills), then those embeddings are combined (e.g., using pooling) to generate a single embedding for that entity type.

Thereafter, a downstream process may request any of the embeddings associated with the corresponding user. The downstream process may send a request that includes a user/member identifier and one or more other values. The user/member identifier is used to look up and identify the appropriate user entity and the one or more other values are used to select one or more of the embeddings associated with user entity. Examples of the one or more other values include a number that indicates a size of the embedding (e.g., 128 or 64), a type of aggregation (e.g., “mean pool” or “max pool”), and an attribute entity type (e.g., “job title” or “employer”)

### Updating Inferred Embeddings Based on Changes to Non-Attribute Entities

In an embodiment, an embedding for a non-attribute entity is updated in response to one or more changes to the non-attribute entity. For example, user updates his/her profile in entity database 110 to indicate a new attribute value, such as indicating a new employer or a new skill. In response to the update, a new inferred embedding for the user is automatically generated (e.g., by inferred embedding generator 140) based on the entity embedding for that new attribute value. The entity embedding for the new attribute value may be a ML embedding or an inferred embedding. If the new (to the user) attribute value is a relatively frequent attribute value in entity database 110, then the embedding for that attribute value is likely to be an ML embedding.

Inferred embedding generator 140 may generate the new or updated inferred embeddings. Inferred embedding generator 140 may determine that a change has occurred from another process. For example, a logging process that manages update requests at entity database 110 logs changes that are made to records in entity database 110. The logging process generates a change record for each change made to a record in entity database 110. A change record identifies an entity record (e.g., an entity record identifier or a user identifier), indicates the type of change (e.g., addition, deletion, update), and indicates one or more values that are being changed, such as a new attribute value, the attribute value that is being deleted, or an attribute value that is replacing a previous attribute value. The inferred embedding generator 140 reads the change records indicated in the change log, either continuously or regularly, for example, every hour. In response to identifying a change record that inferred embedding generator 140 has not yet processed (e.g., as determined based on a timestamp), then inferred embedding generator 140 uses that change record to generate a new inferred embedding for the corresponding non-attribute entity. The new inferred embedding replaces the old or previous inferred embedding for the corresponding non-attribute entity.

Generating a new inferred embedding for a non-attribute entity may involve a pooling technique or other technique, such as autoencoding, each of which involves considering the embeddings for the attribute values that have not changed for the non-attribute entity in addition to the new attribute value.

As another example, if a user updates his/her profile to remove an attribute value, such as removing a skill or an industry, then a new inferred embedding for the user is automatically generated based on the existing attributes and not based on an embedding for the removed attribute value. The new inferred embedding replaces the old or previous inferred embedding for the user. Again, generating the new inferred embedding for the user may involve a pooling or other technique.

In a related embodiment, a new inferred embedding for a non-user entity (e.g., an organization, group, or association) is similarly generated when one or more attribute values of the non-user entity are updated.

### New Non-Attribute Entities

After the most recent set of ML embeddings have been generated, new non-attribute entities may be added to entity database 110. For example, new users may be registering with an online social networking service that maintains entity database 110. When a new user so registers, the online social networking service generates a new entity record that includes profile data that the new user input through a user interface provided by the service.

In an embodiment, inferred embedding generator 140 detects a new (non-attribute) entity record, identifies attribute values in the new entity record, identifies (e.g., looks up in one or more separate tables) an embedding (whether ML or inferred) for each identified attribute value, generates an inferred embedding based on the identified embeddings, and stores data that associates the inferred embedding with the new entity record. Thereafter, the new inferred embedding is available for one or more downstream processes that request an embedding for the new (e.g., user) entity.

### New Attribute Entities

After the most recent set of ML embeddings have been generated, new attribute entities may be added to entity database 110. For example, an existing registered user adds a new skill or a new employer to his/her profile, where entity database 110 did not previously contain any instances of that skill or employer.

In an embodiment, a process similar to process 200 is performed to generate an inferred embedding for a new attribute entity.

In a related embodiment, the process is not performed until a threshold number of instances of the new attribute entity are detected in entity database 110. For example, only after two hundred instances of employer “Company Y” are detected in user profiles will inferred embedding generator 140 generate an inferred embedding for attribute “Company Y.”

### Retraining

The process of generating new ML embeddings to replace current (or “old”) ML embeddings is referred to as “retraining.” Because retraining requires significant time and computing resources, frequent retraining should be avoided. One or more factors may trigger a retraining. Each of the following examples factor may individually trigger a retraining or may trigger a retraining in combination with one or more other factors.

One example factor is the lapse of a certain period of time. For example, if three months have passed since the current set of ML embeddings have been generated, then a retraining is performed. Such a lapse of time may be sufficient to trigger a retraining. Alternatively, as indicated above, the lapse of time may be a necessary, but insufficient on its own, to trigger a retraining.

Another example factor is updates to the entity records in entity database 110. For example, at time T1, a set of ML embeddings and a set of inferred embeddings are generated. Between time T1 and time T2, a subset of the set of inferred embeddings are updated or replaced with new inferred embeddings. If the number of updated or new inferred embeddings is greater than a threshold number (or a threshold percentage of all inferred embeddings or all embeddings, regardless of ML or inferred), then a retraining is triggered. For example, if 20% of inferred embeddings for non-attribute entities have been updated or replaced with new inferred embeddings since the current ML embeddings have been generated, then the retraining is performed. As another example, if the number of new non-attribute entities has increased greater than 10% since the current ML embeddings have been generated, then a retraining is triggered.

An example of a related factor in determining whether to trigger a retraining is the extent to which new/updated inferred embeddings have changed from the inferred embeddings that were replaced by the new/updated embeddings. For example, if the cumulative differences between a set of old inferred embeddings and a corresponding set of new inferred embeddings for the same set of (e.g., non-attribute) entities is greater than a certain amount, then a retraining is performed.

Embodiments are not limited to any particular technique for calculating the cumulative differences. One example technique is root-mean-square error (RMSE). One way to implement RMSE is to (1), for each entity e, divide (a) the L2 norm of (eₜ₋₁−eₜ) by (b) the L2 norm of eₜ₋₁, where e t is the embedding for entity e at time t, and eₜ₋₁ is the embedding for entity e at time t−1 and (2) sum the result of each division. L2 norm calculates a Euclidean distance from the origin. The entities that are considered may be all the entities for which an inferred embedding has been generated in the most recent training at time t−1, or may be a subset of such entities, such as entities whose inferred embeddings have changes since time t−1. The value of the sum indicates an amount that embeddings of the corresponding entities have changed since time t−1. If the sum is greater than a particular threshold (e.g., specified by a user or administrator of system 100), then retraining is triggered; otherwise, the current set of ML embeddings are retained and used by one or more downstream processes.

In an embodiment, a change value (e.g., a RMSE value or L2 norm of (eₜ₋₁−eₜ)) for a particular entity is used to determine whether to publish the updated entity embedding for the particular entity. For example, if the change value is greater than a certain threshold, then the updated entity embedding is not published (or made available) to one or more downstream processes. However, the updated entity embedding may be still stored and associated with the particular entity. Instead, the one or more downstream processes may leverage the previous (or old) version of the entity embedding.

In a related embodiment, different types of entities are associated with different thresholds. For example, entities of type skill may have a higher threshold than entities of type employer. Thus, all else being equal, it is more likely that updated embeddings of entities of type skill will be published than updated embeddings of entities of type employer.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

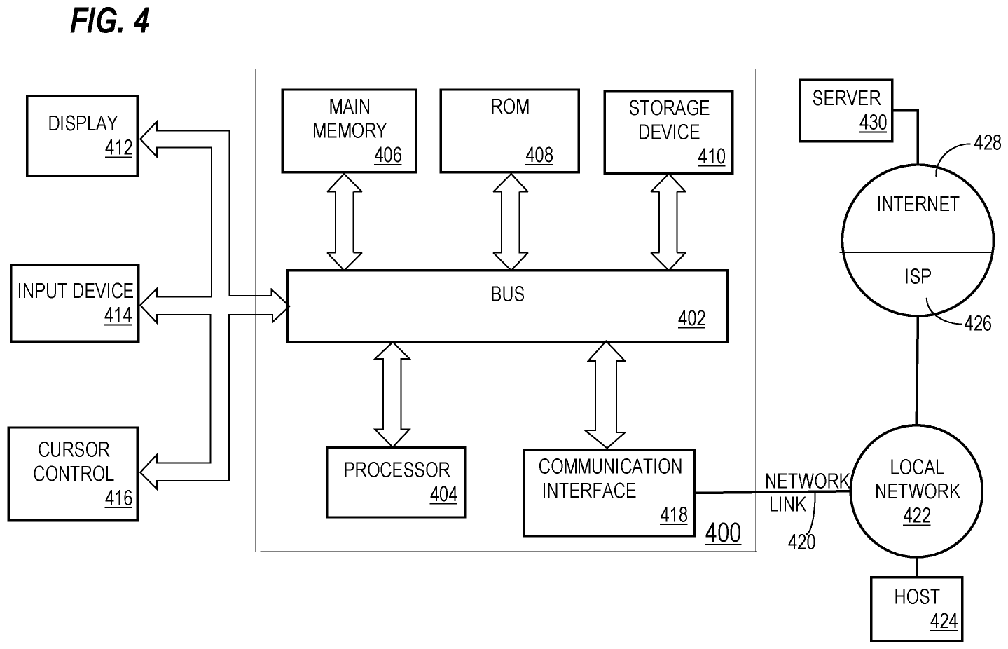

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing a graph that comprises a plurality of nodes representing a set of entities;
identifying a first subset of the set of entities and a second subset of the set of entities;
for each entity in the first subset of the set of entities, using one or more machine learning techniques to generate a machine-learned embedding for said each entity;
for each entity in the second subset of the set of entities:
identifying a subset of entities in the first subset that are associated with said each entity;
identifying one or more embeddings for the subset of entities;
based on the one or more embeddings, generating an inferred embedding for said each entity;
wherein the method is performed by one or more computing devices.

2. The method of claim 1, wherein:
the set of entities includes a first entity of a first entity type;
the set of entities includes a second entity of a second entity type that is different than the first entity type;
identifying the first subset of the set of entities comprises selecting a strict subset of the set of entities based on each entity in the strict subset being an entity of the first entity type;
the second subset of the set of entities includes the strict subset of the set of entities;
the first subset of the set of entities includes at least some entities that are both in the set of entities and outside the strict subset.

3. The method of claim 2, wherein the first entity type is a non-attribute entity type.

4. The method of claim 1, further comprising:
determining a frequency of each entity in a subset of the set of entities;
wherein identifying the first subset of the set of entities comprises selecting a strict subset of the set of entities based on the frequency of each entity in the subset of the set of entities;
wherein the first subset of the set of entities includes the strict subset of the set of entities;
wherein the second subset of the set of entities includes at least some entities that are both in the set of entities and outside the strict subset.

5. The method of claim 4, wherein the set of entities includes attribute entities and non-attribute entities, further comprising:
for each attribute entity in the second subset of the set of entities:
identifying a plurality of non-attribute entities that are associated with said each attribute entity;
identifying a plurality of attribute entities that are associated with the plurality of non-attribute entities;
identifying a plurality of machine-learned embeddings, each of which is associated with at least one attribute entity in the plurality of attribute entities;
generating a particular inferred embedding based on the plurality of machine-learned embeddings.

6. The method of claim 4, further comprising:
storing a plurality of frequency thresholds, each associated with a different entity type of a plurality of entity types;
for each entity in the subset of the set of entities:
determining a frequency of said each entity;
determining, from among the plurality of entity types, a particular entity type of said each entity;
selecting, from among the plurality of frequency thresholds, a particular frequency threshold that corresponds to the particular entity type;
if the frequency of said each entity is higher than the particular frequency threshold, then assigning said each entity to the first subset of the set of entities;
if the frequency of said each entity is lower than the particular frequency threshold, then assigning said each entity to the second subset of the set of entities.

7. The method of claim 1, wherein:
the one or more embeddings are a plurality of embeddings;
generating the inferred embedding comprises performing a pooling operation on the plurality of embeddings.

8. The method of claim 1, wherein generating the inferred embedding for said each entity in the second subset results in a first plurality of inferred embeddings, one for each entity in the second subset, the method further comprising:
after generating the first plurality of inferred embeddings, generating a second plurality of inferred embeddings, one for each entity in the second subset;
based on a comparison between the first plurality of inferred embeddings and the second plurality of inferred embeddings, determining an amount of difference between the first plurality of embeddings and the second plurality of embeddings.

9. The method of claim 1, wherein the plurality of nodes is a first plurality of nodes, the method further comprising:
after generating the inferred embedding for each entity in the second subset, updating the graph to include a second plurality of nodes representing a second set of entities that includes at least some of entities in the set of entities, wherein the second plurality of nodes is different than the first plurality of nodes;
determining whether to generate new machine-learned embeddings for at least some of the entities in the first subset of the set of entities;
in response to determining to generate new machine-learned embeddings for at least some of the entities in the first subset of the set of entities:
identifying a third subset of the second set of entities and a fourth subset of the second set of entities;
for each entity in the third subset of the second set of entities, using the one or more machine learning techniques to generate a second machine-learned embedding for said each entity;
for each entity in the fourth subset of the second set of entities:
identifying a particular subset of entities in the third subset that are associated with said each entity;
identifying one or more second embeddings for the particular subset of entities;
based on the one or more second embeddings, generating a second inferred embedding for said each entity.

10. The method of claim 9, wherein determining whether to generate new machine-learned embeddings is performed based one or more criteria that comprises a lapse of a particular amount of time since the inferred embedding was generated or an amount of change between different sets of inferred embeddings.

11. The method of claim 1, wherein the second subset of the set of entities includes a particular set of entities of a non-attribute type:
for each entity in the particular set of entities, storing a plurality of embeddings in associated with said each entity, wherein the plurality of embeddings includes (1) a second plurality of embeddings, each corresponding to a different attribute of said each entity, and (2) a particular inferred embedding that is an aggregation of the second plurality of embeddings.

12. One or more storage media storing instructions which, when executed by the one or more processors, cause:
storing a graph that comprises a plurality of nodes representing a set of entities;
identifying a first subset of the set of entities and a second subset of the set of entities;
for each entity in the first subset of the set of entities, using one or more machine learning techniques to generate a machine-learned embedding for said each entity;
for each entity in the second subset of the set of entities:
identifying a subset of entities in the first subset that are associated with said each entity;
identifying one or more embeddings for the subset of entities;
based on the one or more embeddings, generating an inferred embedding for said each entity.

13. The one or more storage media of claim 12, wherein:
the set of entities includes a first entity of a first entity type;
the set of entities includes a second entity of a second entity type that is different than the first entity type;
identifying the first subset of the set of entities comprises selecting a strict subset of the set of entities based on each entity in the strict subset being an entity of the first entity type;
the second subset of the set of entities includes the strict subset of the set of entities;
the first subset of the set of entities includes at least some entities that are both in the set of entities and outside the strict subset.

14. The one or more storage media of claim 12, wherein the instructions, when executed by the one or more processors, further cause:
determining a frequency of each entity in a subset of the set of entities;
wherein identifying the first subset of the set of entities comprises selecting a strict subset of the set of entities based on the frequency of each entity in the subset of the set of entities;
wherein the first subset of the set of entities includes the strict subset of the set of entities;
wherein the second subset of the set of entities includes at least some entities that are both in the set of entities and outside the strict subset.

15. The one or more storage media of claim 14, wherein the set of entities includes attribute entities and non-attribute entities, wherein the instructions, when executed by the one or more processors, further cause:
for each attribute entity in the second subset of the set of entities:
identifying a plurality of non-attribute entities that are associated with said each attribute entity;
identifying a plurality of attribute entities that are associated with the plurality of non-attribute entities;
identifying a plurality of machine-learned embeddings, each of which is associated with at least one attribute entity in the plurality of attribute entities;
generating a particular inferred embedding based on the plurality of machine-learned embeddings.

16. The one or more storage media of claim 14, wherein the instructions, when executed by the one or more processors, further cause:
storing a plurality of frequency thresholds, each associated with a different entity type of a plurality of entity types;
for each entity in the subset of the set of entities:
determining a frequency of said each entity;
determining, from among the plurality of entity types, a particular entity type of said each entity;
selecting, from among the plurality of frequency thresholds, a particular frequency threshold that corresponds to the particular entity type;
if the frequency of said each entity is higher than the particular frequency threshold, then assigning said each entity to the first subset of the set of entities;
if the frequency of said each entity is lower than the particular frequency threshold, then assigning said each entity to the second subset of the set of entities.

17. The one or more storage media of claim 12, wherein generating the inferred embedding for said each entity in the second subset results in a first plurality of inferred embeddings, one for each entity in the second subset, wherein the instructions, when executed by the one or more processors, further cause:
after generating the first plurality of inferred embeddings, generating a second plurality of inferred embeddings, one for each entity in the second subset;
based on a comparison between the first plurality of inferred embeddings and the second plurality of inferred embeddings, determining an amount of difference between the first plurality of embeddings and the second plurality of embeddings.

18. The one or more storage media of claim 12, wherein the plurality of nodes is a first plurality of nodes, wherein the instructions, when executed by the one or more processors, further cause:
after generating the inferred embedding for each entity in the second subset, updating the graph to include a second plurality of nodes representing a second set of entities that includes at least some of entities in the set of entities, wherein the second plurality of nodes is different than the first plurality of nodes;
determining whether to generate new machine-learned embeddings for at least some of the entities in the first subset of the set of entities;
in response to determining to generate new machine-learned embeddings for at least some of the entities in the first subset of the set of entities:
identifying a third subset of the second set of entities and a fourth subset of the second set of entities;
for each entity in the third subset of the second set of entities, using the one or more machine learning techniques to generate a second machine-learned embedding for said each entity;
for each entity in the fourth subset of the second set of entities:
identifying a particular subset of entities in the third subset that are associated with said each entity;
identifying one or more second embeddings for the particular subset of entities;
based on the one or more second embeddings, generating a second inferred embedding for said each entity.

19. The one or more storage media of claim 18, wherein determining whether to generate new machine-learned embeddings is performed based one or more criteria that comprises a lapse of a particular amount of time since the inferred embedding was generated or an amount of change between different sets of inferred embeddings.

20. The one or more storage media of claim 12, wherein the second subset of the set of entities includes a particular set of entities of a non-attribute type:
for each entity in the particular set of entities, storing a plurality of embeddings in associated with said each entity, wherein the plurality of embeddings includes (1) a second plurality of embeddings, each corresponding to a different attribute of said each entity, and (2) a particular inferred embedding that is an aggregation of the second plurality of embeddings.
